(19) United States
(12) Patent Application Publication
(10) Pub. No.: US 2009/0161961 A1
(43) Pub. Date: Jun. 25, 2009

(54) Apparatus and method for trimming

(75) Inventors: Eun-Young Kim, Changwon-city (KR); Min-su Kang, Changwon-city (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/317,093

(22) Filed: Dec. 19, 2008

(30) Foreign Application Priority Data
Dec. 21, 2007 (KR) 10-2007-0135737

(51) Int. Cl. G06K 9/00; G06K 9/20

(52) U.S. Cl. 382/195; 382/282

(57) ABSTRACT

Apparatuses and methods for processing a digital image are provided. More particularly, apparatuses and methods for trimming an image, whereby a composition of the image is located and trimmed from a displayed image, are provided. The apparatuses may include a digital signal processing unit which retrieves composition information similar to the composition information of a displayed image, and trims the image to obtain a trimmed image corresponding to an area of the image matching the retrieved composition information.

### CROSS-REFERENCE TO RELATED PATENT APPLICATION

This application claims the benefit of Korean Patent Application No. 10-2007-0135737, filed on Dec. 21, 2007 in the Korean Intellectual Property Office, the entire contents of which is incorporated herein by reference.

### BACKGROUND OF THE INVENTION

1. Field of the Invention

The present invention relates to apparatuses and methods for processing a digital image. More particularly, to apparatuses and methods for trimming an image, whereby composition information similar to composition information of a displayed image is retrieved and used to trim the displayed image.

2. Description of the Related Art

After an image is captured by a digital image processing apparatus, if the composition of the image is not satisfactory when reproduced, a trimming function for cutting a part of the image can be executed. The trimming function allows a part of a stored image to be stored according to a user's selection. Accordingly, trimming is mainly used when only parts of an image are needed or when parts of an image are required to be enlarged and stored.

However, alternative compositions that may improve the composition of an image are not directly provided in a digital image processing apparatus. Producing a good composition of an image is a difficult job for an ordinary user who is not an expert. Although a user can change the composition of a captured image by using an editing function, the changed image itself, which is directly changed by the user, may not have an optimized composition.

### SUMMARY OF THE INVENTION

The present invention provides apparatuses and methods for trimming an image, where composition information similar to the composition of a displayed image is retrieved from a database (DB) storing composition information, and the displayed image is trimmed using the retrieved composition information.

According to an embodiment of the present invention, there is provided an apparatus for trimming an image, including a digital signal processing unit retrieving composition information similar to composition information of a displayed image and trimming the image such that an area of the image matches the retrieved composition information, thereby obtaining a trimmed image.

In an embodiment, the displayed image may be a live view image or an arbitrary stored image.

In an embodiment, the digital signal processing unit may display the displayed image and the trimmed image simultaneously.

In embodiments, the digital signal processing unit may include: a composition information extraction unit configured to extract composition information from the image; a database (DB) storing composition information ; a retrieval unit configured to retrieve composition information from the DB similar to the extracted composition information of the image; a frame generation unit configured to indicate the area of the image matching the retrieved composition information; and a trimming unit configured to trim the image.

In embodiments, the composition information extraction unit may extract composition information through face recognition if the image is an image of a person.

In embodiments, the composition information extraction unit may extract composition information through edge detection if the image is a background image.

In embodiments, the composition information extracted by the composition information extraction unit may be displayed on a part of the live view image.

In embodiments, the composition information retrieved from the DB is displayed on a part of the live view image.

According to an embodiment of the present invention, there is provided an apparatus for trimming a digital image including: a composition information extraction unit configured to extract composition information from a live view image responsive to receiving a first signal of a shutter-release button; a composition information DB storing composition information of images; a retrieval unit configured to retrieve composition information from the composition information DB similar to the extracted composition information of the live view image; a frame generation unit configured to indicate an area of the live view image matching the retrieved composition information; and a trimming unit configured to trim the image to obtain a trimmed image corresponding to the matched area responsive to receiving a second signal of the shutter-release button.

According to an embodiment of the present invention, there is provided an apparatus for trimming an image, including: a composition information extraction unit configured to extract composition information from an arbitrary reproduced image responsive to receiving a first signal of a shutter-release button; a composition information DB storing composition information of images; a retrieval unit configured to retrieve composition information from the composition information DB similar to the extracted composition information of the reproduced image; a frame generation unit configured to indicate an area of the reproduced image matching the retrieved composition information; and a trimming unit configured to trim the image to obtain a trimmed image corresponding to the matched area responsive to a second signal of the shutter-release button.

According to another embodiment of the present invention, there is provided a method of trimming an image, the method including: retrieving composition information similar to composition information of an image; and trimming the image to obtain a trimmed image corresponding to an area of the image matching the retrieved composition information.

The method may further include displaying the displayed image and the trimmed image simultaneously.

In embodiments, the image may be a live view image or a stored image.

In an embodiment, the step of retrieving of the composition information may include: extracting composition information from the image; and retrieving composition information from a DB storing composition information of images, where the retrieved composition information is similar to the extracted composition information of the image.

In an embodiment, the composition information extracted from the image may be displayed on a part of the live view image.

In an embodiment, the composition information retrieved from the composition information DB may be displayed on a part of the live view image.

In an embodiment, the step of retrieving of the composition information, may include using face recognition, and/or edge detection.

In an embodiment, the step of trimming the image to obtain a trimmed image corresponding to an area of the image matching the retrieved composition information may include: indicating the area of the live view image matching the retrieved composition information by a frame; and trimming the image to obtain a trimmed image corresponding to the frame.

According to another embodiment of the present invention, there is provided a method of trimming an image, the method including: extracting composition information from a live view image responsive to receiving a first signal of a shutter-release button; retrieving composition information from a composition information DB storing composition information of images, the retrieved composition information being similar to the extracted composition information of the live view image; indicating a an area of the live view image matching the retrieved composition information; and trimming the image to obtain a trimmed image corresponding to the area matching the retrieved composition information responsive to receiving a second signal of the shutter-release button.

According to another embodiment of the present invention, there is provided a method of trimming an image, the method including: extracting composition information from a reproduced image responsive to a first shutter-release button; retrieving composition information from a composition information DB storing composition information of images, the retrieved composition information being the similar to the extracted composition information of the reproduced image; indicating an area of the reproduced image matching the retrieved composition information; and trimming the image to obtain a trimmed image corresponding to the area of the reproduced image matching the retrieved composition information responsive to a second signal of the shutter-release button is input.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view illustrating an example of the front and top sides of a digital image processing apparatus;

FIG. 2 is a rear view illustrating an example of the backside of the digital image processing apparatus illustrated in FIG. 1;

FIG. 3 is a block diagram illustrating an example of a structure of an apparatus for trimming an image, according to an embodiment of the present invention;

FIG. 4 is a diagram explaining an example of a composition information extraction unit of the apparatus illustrated in FIG. 3, according to an embodiment of the present invention;

FIG. 5 is a diagram illustrating an example of an composition information stored in a composition information DB in the apparatus for trimming an image illustrated in FIG. 3, according to an embodiment of the present invention;

FIG. 6 is a diagram illustrating an example of composition information detected in the apparatus for trimming an image illustrated in FIG. 3 on a part of an image, according to an embodiment of the present invention;

FIG. 7 is a diagram illustrating an example of an area of an image matching composition information indicated by a frame in the apparatus for trimming an image illustrated in FIG. 3, according to an embodiment of the present invention;

FIG. 8 is a diagram illustrating an example of an image obtained by trimming an image indicated by a frame in the apparatus for trimming an image illustrated in FIG. 3, according to an embodiment of the present invention;

FIG. 9 is an example of a flowchart illustrating a method of trimming an image, according to an embodiment of the present invention; and

FIG. 10 is an example of a flowchart illustrating a method of trimming an image, according to another embodiment of the present invention.

### DETAILED DESCRIPTION OF THE INVENTION

The present invention will now be described more fully with reference to the accompanying drawings, in which exemplary embodiments of the invention are shown.

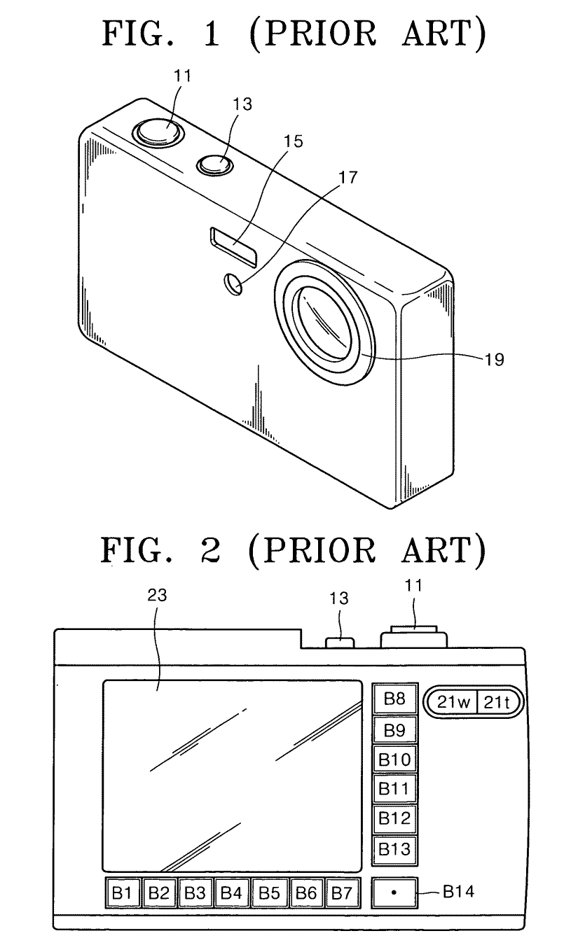

FIG. 1 is a perspective view illustrating an example of the front and top sides of a digital image processing apparatus. A signal from a power button 13 is input in order to provide power to and operate the digital image processing apparatus. A shutter-release button 11 is opened and closed in order to expose a charged coupled device (CCD) to light for a predetermined time, and records an image on the CCD by appropriately exposing an object to light by using an iris (not shown)

The shutter-release button 11 generates first and second image photographing signals according to an input from a photographer. If a first signal of the shutter-release button 11 is input as a half-shutter signal, the digital image processing apparatus focuses and adjusts the amount of light. In this case, if an object is in focus, a green light of a display unit 23 is turned on. If the apparatus is focused and the amount of light is adjusted by the first signal of the shutter-release button 11, a second signal of the shutter-release button 11 is input as a complete shutter signal, thereby photographing an image.

A flash 15 momentarily emits bright light when an image is captured in a dark place. Flash modes may include automatic flash, compulsory emission, emission prohibition, red eye reduction, slow synchronization and the like.

An auxiliary light 17 supplies light to an object so that the digital image processing apparatus can focus quickly, accurately, and automatically when the amount of light is not sufficient or when an image is captured at night.

A lens unit 19 receives light from an external light source to process an image.

FIG. 2 is a rear view illustrating an example of the backside of the digital image processing apparatus illustrated in FIG. 1. Referring to FIG. 2, the digital image processing apparatus includes buttons B1˜B14, a wide-angle-zoom button (21W), a telephoto-zoom button (21T), and a display unit 23.

According to an input of the wide-angle-zoom button (21W) or the telephoto-zoom button (21T), the angle of view is narrowed or widened. In particular, the wide-angle-zoom button (21W) and telephoto-zoom button (21T) are used when the size of a selected exposed area is desired to be changed. If a wide-angle-zoom button (21W) signal is input, the size of the selected exposed area is decreased, and if a telephoto-zoom button (21T) signal is input, the size of the selected exposed area is increased.

The buttons B1˜B14 are disposed in a row and a column adjacent to the display unit 23. Each of the buttons B1˜B14 disposed in a row and a column adjacent to the display unit 23 may have a touch sensor (not shown) or a contact switch (not shown).

That is, a touch sensor may be disposed in each of the buttons B1˜B14. In this case, while the buttons B1˜B7 of row or the buttons B8˜B14 of the column are touched, an arbitrary value (for example, a color or brightness) from main menu items can be selected or sub menu icons included in a main menu icon can be activated by moving upward/downward/left/right.

Also, a contact switch may be disposed in each of the buttons B1˜B14, and a main menu icon and a sub menu icon can be directly selected, thereby executing a corresponding function. The touch sensor may require a relatively weaker touch than that required by the contact switch, and the contact switch input requires a relatively stronger touch than that of the touch sensor input.

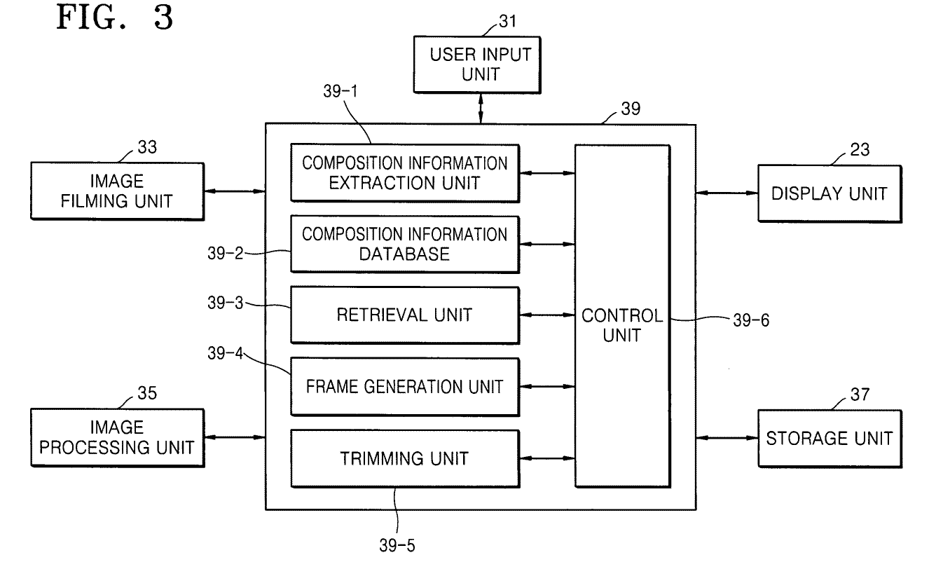

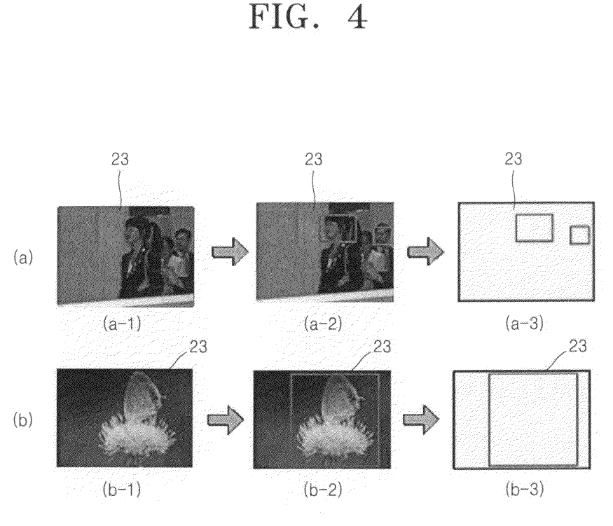

FIG. 3 is a block diagram illustrating an example of a structure of an image trimming apparatus, according to an embodiment of the present invention. Referring to FIG. 3, the image trimming apparatus according to the current embodiment includes a display unit 23, a user input unit 31, an image pickup unit 35, an image processing unit 35, a storage unit 37, and a digital signal processing unit 39.

The user input unit 31 may further include, referring back to FIG. 2, a shutter release button 11 which is opened and closed in order to expose the CCD to light for a predetermined time, a power button 13 input for providing power, a wide-angle-zoom button (21W) and a telephoto-zoom button (21T) for widening and narrowing the angle of view, and buttons B1˜B14 disposed in a row and a column adjacent to a display unit 23 having touch sensors or contact switches. The image pickup unit 33 may include a shutter, a lens unit, an iris, a CCD, and an analog-to-digital converter (ADC) all of which are not shown. The shutter is a device for adjusting the amount of light for exposure in connection with the iris. The lens unit receives light from an external light source and processes an image. In this case, according to the degree of opening and closure of the iris, the iris adjusts the amount of incident light. The degree of opening and closure is controlled by the digital signal processing unit 39.

The CCD accumulates the amount of light input through the lens unit and according to the accumulated amount of light, an image captured in the lens unit is output in synchronization with a vertical synchronization signal. Acquisition of an image in the digital image processing apparatus is performed by the CCD which converts light reflected from an object into an electrical signal. In order to obtain a color image by using the CCD, a color filter is required, and generally, a filter (not shown) referred to as a color filter array (CFA) is employed. A CFA allows light of only one color to pass through one pixel and has a structure having a regular array. According to the array structure, the CFA has a variety of shapes. The ADC converts an analog image signal output from the CCD into a digital signal.

The image processing unit 35 in this example processes the signal of the digitized raw data so that an image of the digitized raw data can be displayed. The image processing unit 35 in this example removes a black level caused by a dark current occurring in the CCD and CFA. The image processing unit 35 in this example performs gamma correction for encoding information according to nonlinearity of human vision. The image processing unit 35 in this example performs CFA interpolation in which a Bayer pattern implemented with RGRG lines and GBGB lines of the gamma-corrected predetermined data is interpolated. The image processing unit 35 in this example transforms the corrected RGB signal into a YUV signal, performs edge compensation by which the Y signal is filtered with a high pass filter to make an image clearer, performs color correction for correcting the color values of U and V signals by using a standard color coordinate system, and removes noise in these signals. The image processing unit 35 in this example compresses and processes the Y, U, and V signals, in which noise is removed, thereby generating a Joint Photographic Experts Group (JPEG) file. The generated JPEG file in this example is displayed in the display unit 23, and stored in the storage unit 37. All these operations of the image processing unit 35 in this example are controlled by the digital signal processing unit 39.

The digital signal processing unit 39 retrieves composition information similar to the composition information of a displayed image, and trims an area of the image matching the retrieved optimum composition information. In this case, the displayed image may be a live view image or an image stored in the storage unit 37. In an embodiment, the digital signal processing unit 39 retrieves the optimum composition information similar to the composition information of a displayed image.

Referring to FIG. 3 again, the digital signal processing unit 39 in this example controls image trimming and includes a composition information extraction unit 39-1, a composition information DB 39-2, a retrieval unit 39-3, a frame generation unit 39-4, a trimming unit 39-5, and a control unit 39-6.

In this example, the control unit 39-6 controls the composition information extraction unit 39-1 which extracts composition information from a displayed live view image or from an image selected from the storage unit 37, which may be reproduced on the display unit 23. If the displayed image is an image of a person, the composition information extraction unit 39-1 may extract composition information through face recognition, and if the displayed image is a background image, the composition information extraction unit 39-1 may extract composition information through edge detection.

If the displayed image is an image of a person as illustrated in the example of FIG. 4(A-1), the composition information extraction unit 39-1 may apply a face recognition algorithm to the image, thereby extracting composition information. The composition information extraction unit 39-1 may detect the size, location, and direction of a face in the displayed image. The size of the face may be detected according to the color or edges. The location of the face may be calculated according to the distance between the center part of an extracted face and a preset center part of the display unit 23. The direction of the face may be detected in the form of a triangle formed by the eyes and mouth from the extracted face. The result of face recognition of the face image illustrated in FIG. 4(A-1) is shown in FIG. 4 (A-2), and composition information extracted by the composition information extraction unit 39-1 is illustrated in FIG. 4(A-3).

In an embodiment, if the displayed image is a background image, for example the background image illustrated in FIG. 4(B-1), the composition information extraction unit 39-1 may extract composition information through applying edge detection to the image. In an embodiment, the composition information extraction unit 39-1 extracts edges by applying a high pass filter to the displayed image. The result of edge detection of the background image illustrated in FIG. 4(B-1) is shown in FIG. 4(B-2), and the composition information extraction unit 39-1 may extract the composition information illustrated in FIG. 4(B-3).

The composition information detected by the composition information extraction unit 39-1 may be displayed together with the displayed image as illustrated in the examples of FIGS. 4(A-2) and 4(B-2), and/or may be displayed on a part of the displayed image, for example, as another screen with a small size as illustrated in FIG. 6.

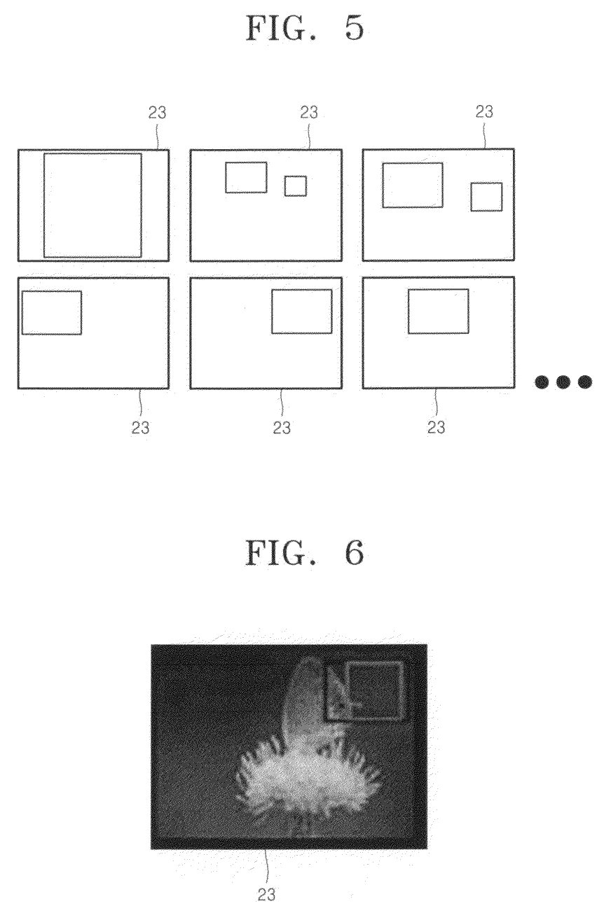

In the composition information DB 39-2, composition information of images is stored. As illustrated in the examples of FIG. 5, the composition information stored in the composition information DB 39-2 may include composition information that may be used to match composition information of an image and then optionally to trim the image.

In an embodiment, the control unit 39-6 controls, the retrieval unit 39-3 to retrieve composition information from the composition information DB 39-2 similar to the composition information extracted by the composition information extraction unit 39-1. The composition information retrieved by the retrieval unit 39-3 may be displayed on part of the displayed image as illustrated in the example of FIG. 6, or the composition information extracted by the composition information extraction unit 39-1 and the composition information retrieved from the composition information DB 39-2 may be displayed at the same time.

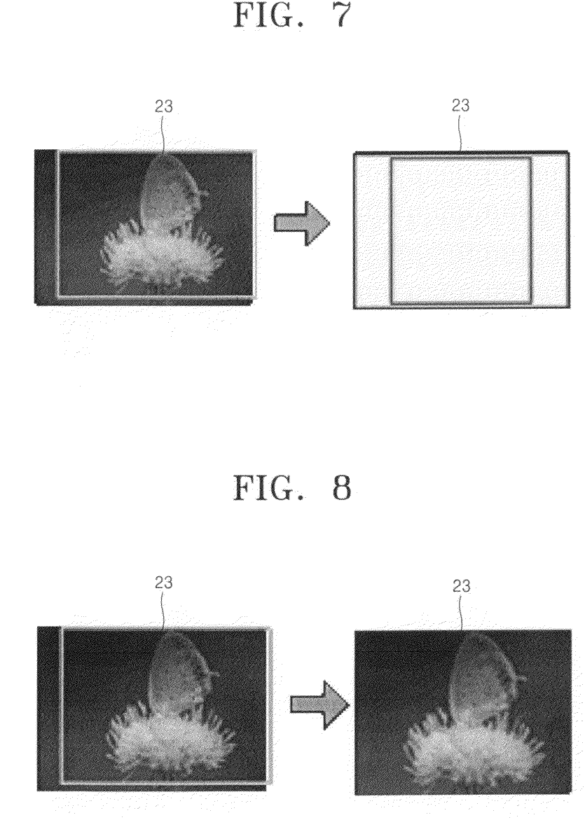

In an embodiment, the control unit 39-6 controls the frame generation unit 39-4 to indicate as a frame an area of an image matching the composition information retrieved by the retrieval unit 39-3. FIG. 7 illustrates an example of the optimum composition information retrieved by the retrieval unit 39-3 applied to a displayed image and indicated by a frame.

In an embodiment, the control unit 39-6 controls the trimming unit 39-5 to trim the frame generated by the frame generation unit 39-4. FIG. 8 illustrates an example of the result obtained by trimming an image in which composition information is indicated by a frame.

In an embodiment of the present invention, the image trimmed by the trimming unit 39-5 and the displayed image may be stored separately. For example, when the displayed image is a live view image, if the first signal from the shutter-release button 11 is received, the composition information of the live view is extracted, and a frame is generated by extracting composition information similar to the extracted composition information from the composition information DB 39-2. Then, if the second signal from the shutter-release button 11 is received, the generated frame is trimmed and stored, and at the same time, the untrimmed original live view image is captured and stored. Then, according to the user's selection, the trimmed image and the untrimmed image can be displayed simultaneously and compared with each other.

In an embodiment, when the displayed image is an image stored in the storage unit 37, the composition information of a reproduced image is extracted using the buttons B1˜B14 having corresponding preset functions, and a frame is generated by extracting composition information similar to the composition information extracted from the composition information DB 39-2. In an embodiment, the generated frame is then trimmed and separately stored. In an embodiment, the previous reproduced image is not deleted. Then, according to the user's selection, the trimmed image and the untrimmed image can be displayed simultaneously and compared with each other.

In an embodiment of the present invention, a predetermined composition selection mode may be provided in a digital image processing apparatus. In the predetermined composition selection mode, if an image is displayed, the composition is automatically selected, a frame is generated, and a function for trimming according to the generated frame can be provided.

In an embodiment, the composition information DB 39-2 may provide not only one composition information item similar to the extracted composition information, but also provide a plurality of similar composition information items that can be selected by the user.

In an embodiment, the number of items to be trimmed is not limited to one. Assuming that N optimum compositions detected in the composition DB 39-2 corresponding to one image exist, N images can be generated and trimming can be performed using a variety of methods. That is, an image can be trimmed in a variety of ways and stored separately.

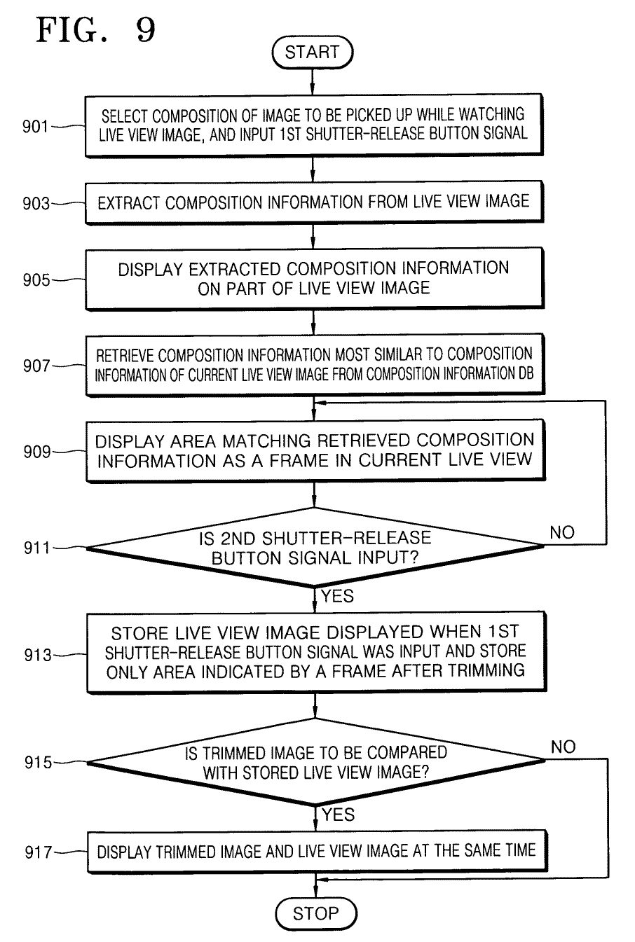

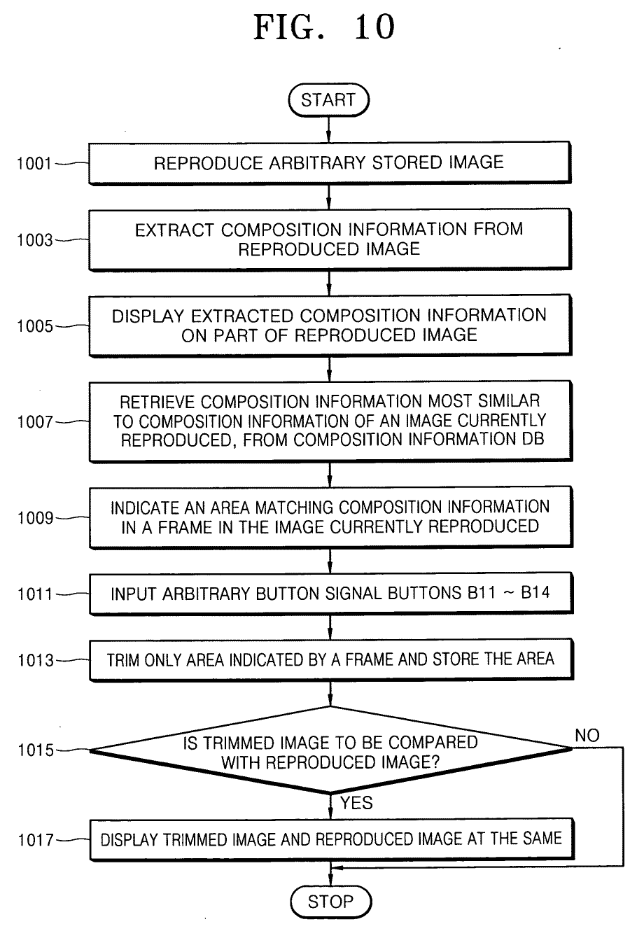

A method of trimming an image according to an embodiment of the present invention will now be explained in more detail with respect to FIGS. 9 and 10. The image trimming method according to the current embodiment may be performed by a digital image processing apparatus as illustrated in FIG. 3. A main algorithm of the method may be executed by the digital signal processing unit 39 with help from peripheral elements in the apparatus.

FIG. 9 is a flowchart illustrating an example of a method of trimming an image, according to an embodiment of the present invention.

In an embodiment, if a user operates the digital image processing apparatus and selects a photographing mode, a live view image is displayed on the display unit 23, and the user can select the photographing composition while watching the displayed live view and the user may input a first signal of the shutter-release button 11 in operation 901.

The digital signal processing unit 39 receives the first signal of the shutter-release button 11 and extracts composition information from the live view image in operation 903. If the displayed image is an image of a person as illustrated in FIG. 4A, the digital signal processing unit 39 may extract composition information through face recognition, and if the displayed image is a background image as illustrated in FIG. 4B, the digital signal processing unit 39 may extract composition information through edge detection.

In an embodiment, the digital signal processing unit 39 displays the extracted composition information on a part of the live view image in operation 905. The digital signal processing unit 39 may display the detected composition information together with the displayed image as illustrated in FIGS. 4(A-3) and 4(B-3) or may display the detected composition information as another screen on part of the displayed image as illustrated in FIG. 6.

In an embodiment, the digital signal processing unit 39 may then retrieve composition information similar to the composition information of the current live view image from the internal composition information DB 39-2 in operation 907. As illustrated in FIG. 5, a variety of composition information items with which the composition information of the current live view image can be corrected are stored in the composition information DB 39-2.

In an embodiment, the digital signal processing unit 39 indicates an area on the current live view image matching the composition information retrieved from the composition information DB 39-2 and indicated by a frame in operation 909. FIG. 7 illustrates an example of the composition information retrieved by the digital signal processing unit 39 applied to a displayed image and indicated by a frame.

In an embodiment the digital signal processing unit 39 may then determine whether or not a signal of the second shutter-release button 11 is received in operation 911.

If the second signal of the shutter-release button 11 is received, then some embodiments can be broken down to two cases. First, if the second signal of the shutter-release button 11 is received, the digital signal processing unit 39 trims the image indicated by a frame and stores the result. FIG. 8 illustrates an example of the result obtained by trimming an image in which composition information is indicated by a frame.

The second case will now be explained with reference to operations 913 through 917.

If the second signal of the shutter-release button 11 is received, the digital signal processing unit 39 stores the live view image displayed when the first signal of the shutter-release button 11 is received, and at the same time trims the image indicated by the frame and stores the trimmed image in operation 913.

Then, when the trimmed image is to be compared with the stored live view image in operation 915, the trimmed image and the live view image are displayed simultaneously on the display unit 23 in operation 917.

In addition and/or alternatively, the composition information DB 39-2 may provide not only one composition information item similar to the extracted composition information, but also provide a plurality of similar composition information items that can be selected by the user.

In addition, the number of items to be trimmed is not limited to one. Assuming that N compositions detected in the composition DB 39-2 corresponding to one image exist, N images can be generated and trimming can be performed using a variety of methods. That is, an image can be trimmed in a variety of ways and stored separately.

FIG. 10 is a flowchart illustrating an example of a method of trimming an image, according to another embodiment of the present invention and illustrates a method of trimming a reproduced image selected from the storage unit 37.

In an embodiment, if the user operates the digital image processing apparatus and selects a reproduction mode, the selected stored image is reproduced on the display unit 23 in operation 1001.

In an embodiment, if the selected image is reproduced, the digital signal processing unit 39 extracts composition information from the reproduced image in operation 1003. In an embodiment, if the displayed image is an image of a person as illustrated in FIG. 4A, the digital signal processing unit 39 extracts composition information through face recognition. In an embodiment, if the displayed image is a background image as illustrated in FIG. 4B, the digital signal processing unit 39 extracts composition information through edge detection.

In an embodiment, the digital signal processing unit 39 displays the extracted composition information on a part of the reproduced image in operation 1005. The digital signal processing unit 39 may display the detected composition information together with the displayed image as illustrated in FIGS. 4(A-3) and 4(B-3) or may display the detected composition information as another screen on a part of the displayed image as illustrated in FIG. 6.

In an embodiment, the digital signal processing unit 39 may then retrieve composition information similar to the composition information of the current reproduced image from the internal composition information DB 39-2 in operation 1007. As illustrated in the example of FIG. 5, a variety of composition information items for changing the composition information of the current reproduced image are stored in the composition information DB 39-2. The changed composition information of the current reproduced image may improve or correct the composition information of the current reproduced image.

In an embodiment, the digital signal processing unit 39 indicates an area on the current reproduced image matching the composition information retrieved from the composition information DB 39-2 and indicated by a frame in operation 1009. FIG. 7 illustrates an example of the composition information retrieved by the digital signal processing unit 39 being applied to a displayed image and indicated by a frame.

In an embodiment, the digital signal processing unit 39 may then receive inputs of, for example, the buttons B1˜B14 having preset trimming functions or the shutter-release button 11 in operation 1011, and trims only an area indicated by a frame and stores the image in operation 1013. In this case, the trimmed image may be separately from the reproduced image. That is, the reproduced image is not deleted. However, according to the user's selection, the reproduced image may be deleted. FIG. 8 illustrates an example of the result obtained by trimming an image in which optimum composition information is indicated by a frame.

In some embodiments, the method may end with operation 1013. Some embodiments, continue with operations 1015 and 1017.

In an embodiment, when the trimmed image is to be compared with the reproduced image in operation 1015, the trimmed image and the reproduced image are displayed simultaneously on the display unit 23 in operation 1017.

In another embodiment, the composition information DB 39-2 may provide not only one composition information item similar to the extracted composition information, but also provide a plurality of similar optimum composition information items that the user can select.

In an embodiment, the number of items to be trimmed is not limited to one. Assuming that N matching compositions detected in the composition DB 39-2 corresponding to one image exist, N images can be generated and trimming can be performed using a variety of methods. That is, an identical image can be trimmed in a variety of ways and stored separately.

In an embodiment, composition information similar to the composition of a displayed image is retrieved from a DB, and based on the composition information, the displayed image is trimmed, thereby obtaining the optimum composition of an image, and maximizing satisfaction of a user.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet).

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An apparatus for trimming an image, comprising a digital signal processing unit retrieving composition information similar to composition information of a displayed image and trimming the image such that an area of the image matches the retrieved composition information, thereby obtaining a trimmed image.

2. The apparatus of claim 1, wherein the displayed image is a live view image or a stored image.

3. The apparatus of claim 1, wherein the digital signal processing unit displays the displayed image and the trimmed image simultaneously.

4. The apparatus of claim 1, wherein the digital signal processing unit comprises:
a composition information extraction unit extracting composition information from the image;
a database (DB) storing composition information of arbitrary images;
a retrieval unit retrieving composition information from the DB similar to the extracted composition information of the image;
a frame generation unit indicating the predetermined area of the image matching the retrieved composition information; and
a trimming unit trimming the generated frame.

5. The apparatus of claim 4, wherein the composition information extraction unit extracts composition information through face recognition if the image is an image of a person.

6. The apparatus of claim 4, wherein the composition information extraction unit extracts composition information through edge detection if the image is a background image.

7. The apparatus of claim 4, wherein at least one of the composition information extracted by the composition information extraction unit and the composition information retrieved from the DB is displayed on a part of the live view image.

8. An apparatus for trimming an image as a digital image processing apparatus comprising:
a composition information extraction unit extracting composition information from a live view image by responsive to receiving a first signal of a shutter-release button;
a composition information DB storing composition information of arbitrary images;
a retrieval unit retrieving composition information from the composition information DB similar to the extracted composition information of the live view image;
a frame generation unit indicating an area of the live view image matching the retrieved composition information; and
a trimming unit trimming the image to obtain a trimmed image corresponding to the area responsive to receiving a second signal of the shutter-release button.

9. An apparatus for trimming an image, comprising:
a composition information extraction unit extracting composition information from a reproduced image responsive to receiving a first signal of a shutter-release button;
a composition information DB storing composition information of images;
a retrieval unit retrieving composition information from the composition information DB similar to the extracted composition information of the reproduced image;
a frame generation unit indicating an area of the reproduced image matching the retrieved composition information; and
a trimming unit trimming the image to obtain a trimmed image corresponding to the area responsive to receiving a second signal of the shutter-release button.

10. A method of trimming an image, the method comprising:
retrieving composition information similar to composition information of an image; and
trimming the image to obtain a trimmed image corresponding to an area of the image matching the retrieved composition information.

11. The method of claim 10, further comprising displaying the displayed image and the trimmed image simultaneously.

12. The method of claim 11, wherein the image is a live view image or a stored image.

13. The method of claim 10, wherein the retrieving of the composition information comprises:
extracting composition information from the image; and
retrieving composition information from a DB storing composition information of arbitrary images, the retrieved composition information being the similar to the extracted composition information of the image.

14. The method of claim 13, wherein at least one of the extracted composition information and the composition information retrieved from the composition information DB is displayed on a part of the live view image.

15. The method of claim 13, wherein, in the retrieving of the composition information, if the image is an image of a person, the composition information is extracted through face recognition, and if the image is a background image, the composition information is extracted through edge detection.

16. The method of claim 10, wherein the trimming the image to obtain a trimmed image corresponding to the predetermined area of the image comprises:
indicating an area of the live view image matching the retrieved composition information by a frame; and
trimming the image to obtain a trimmed image corresponding to the frame.

17. A method of trimming an image, the method comprising:
extracting composition information from a live view image responsive to receiving a first signal of a shutter-release button;
retrieving composition information from a composition information DB storing composition information of arbitrary images, the retrieved composition information being the most similar to the extracted composition information of the live view image;
indicating an area of the live view image matching the retrieved composition information; and
trimming the image to obtain a trimmed image corresponding to an area responsive to receiving a second signal of the shutter-release button.

18. A method of trimming an image, the method comprising:
extracting composition information from a reproduced image by inputting a first shutter-release button;
retrieving composition information from a composition information DB storing composition information of images, the retrieved composition information being the similar to the extracted composition information of the reproduced image;
indicating am area of the reproduced image matching the retrieved composition information; and
trimming the image to obtain a trimmed image corresponding to the area responsive to receiving a second signal of the shutter-release button.
